(19) United States
(12) Patent Application Publication
(10) Pub. No.: US 2025/0209999 A1
(43) Pub. Date: Jun. 26, 2025

(54) LOW MOTION BLUR DISPLAYS WITH VARIABLE REFRESH RATES

(71) Applicant: NVIDIA Corporation, Santa Clara, CA (US)

(72) Inventor: Gerrit Ary Slavenburg, Seaside, CA (US)

(21) Appl. No.: 18/981,925

(22) Filed: Dec. 16, 2024

Related U.S. Application Data
(60) Provisional application No. 63/612,579, filed on Dec. 20, 2023.

(51) Int. Cl. G09G 3/34

(52) U.S. Cl. CPC G09G 3/3406; G09G 2320/0247; G09G 2320/0257; G09G 2320/064; G09G 2340/0435

(57) ABSTRACT

Disclosed are systems and techniques for low motion blue displays with variable refresh rates. The techniques include generating a predicted frame duration for a first frame, determining an actual frame duration for the first frame, and causing the first frame to be displayed by operating a backlight of a display in a first mode. Operating the backlight of the display in the first mode includes pulsing the backlight of the display for the first frame at a first time for a fraction of the predicted frame duration and pulsing the backlight of the display for the first frame at a second time based on a difference between the predicted frame duration and the actual frame duration.

### RELATED APPLICATIONS

This application claims the benefit of U.S. Provisional Patent Application No. 63/612,579, filed Dec. 20, 2023, entitled “Low Motion Blur Variable Refresh”, the contents of which are incorporated by reference in its entirety herein.

### TECHNICAL FIELD

At least one embodiment pertains to hold-type display, and more specifically to pulsing a backlight of a hold-type display to achieve low motion blur.

### BACKGROUND

Hold-type displays can maintain an image for the entire duration of a frame until the image is overwritten. A moving object can be presented on the display, and the human eye may begin tracking the motion. Because the moving object is “held” on the display in the same position for a frame time, the difference between where the object should be at a given point in time and where it is displayed at that point in time can be perceived as blur.

### BRIEF DESCRIPTION OF THE DRAWINGS

FIG. 1 is a block diagram of an example system for low motion blur displays with variable refresh rates, according to at least one embodiment.

FIG. 2 is a block diagram of an example system for low motion blur displays with variable refresh rates, according to at least one embodiment.

FIG. 3 includes example voltage graphs depicting voltage provided to a backlight of a hold-type display for low motion blur with variable refresh rates, according to at least one embodiment.

FIG. 4 includes example voltage graphs depicting voltage provided to a backlight of a hold-type display when transitioning from a low motion blur mode to a constant backlight mode and back, according to at least one embodiment.

FIG. 5 includes example voltage graphs depicting voltage provided to a backlight of a hold-type display when transitioning from a low motion blur mode to a pulse width modulation backlight mode and back, according to at least one embodiment.

FIG. 6 is a flow diagram of an example method for low motion blur displays with variable refresh rates, according to at least one embodiment.

FIG. 7 is a block diagram illustrating an exemplary computer system, in accordance with at least one embodiment of the present disclosure.

### DETAILED DESCRIPTION

As opposed to hold-type displays that maintain an image for the entire duration of a frame, a pulsed display, such as a cathode-ray tube (CRT) display, may briefly “flash” an image and then briefly “flash” the next image when it is ready. Each time the image is flashed, the moving object is at the right position. If the flashing is done fast enough, the human eye may perceive smooth motion without blurring.

To reduce the perceived motion blur of a hold-type display, a backlight of the hold-type display can be pulsed to replicate a pulsed display (e.g., a CRT display). In some cases, the backlight may be pulsed for a fraction of the frame duration. However, as the frame duration varies, the perceived brightness of each frame may vary, causing undesirable flicker. In some cases, to reduce the amount of perceived flicker, the backlight may be pulsed twice for a particular frame. The first pulse may be for a fraction of a frame duration at a target frame rate (e.g., 144 Hz). For example, the first pulse may be for a fixed duration for every frame based on the fixed target frame rate. The second pulse may be a lower-amplitude pulse and may have a duration based on a difference between the frame duration at the target frame rate and the actual frame duration of a particular frame. However, if the actual frame rate is not close to the target frame rate, one or more visual artifacts may be observed (e.g., the long duration low-amplitude pulse may case the frame to appear smeared).

Aspects of the present disclosure address the above and other deficiencies by providing low motion blur for displays with variable refresh rates. To achieve low motion blur at variable frame rates, a backlight of a display may be pulsed twice for each frame. The duration of the first pulse (e.g., “main pulse”) may be based on a predicted frame duration for a particular frame. For example, the duration of the main pulse may be a fraction (e.g., 25%, 10%, 50%, etc.) of the predicted frame duration for a particular frame. The duration of the second pulse (e.g., “runt pulse”) may be based on a difference between the predicted frame duration for a particular frame and an actual frame duration of the frame.

For example, a display control circuit may receive a first frame at time T1. The display control circuit may predict that the second frame will be received at time Tp. The display control circuit may actually receive the second frame at time Ta. The predicted frame duration (Dp) may be equal to Tp−T1. The actual frame duration (Da) may be equal to Ta−T1. In such a case, the duration of the main pulse may be equal to Fm(Dp), where Fm is a main-pulse fractional coefficient between 0 and 1. For example, the duration of the main pulse may be equal to 25% of the predicted duration (e.g., 0.25*Dp).

If the actual frame duration Da is greater than the predicted frame duration Dp, the duration of the runt pulse may be equal to Fr(Da−Dp), where Fr is a runt-pulse fractional coefficient between 0 and 1. For example, the duration of the runt pulse may be equal to 25% of the difference between the predicted duration and the actual duration (e.g., 0.25*(Da−Dp)). In some embodiments, the main-pulse fractional coefficient Fm is the same as the runt-pulse fractional coefficient Fr. In some embodiments, the main-pulse fractional coefficient Fm is different than the runt-pulse fractional coefficient Fr.

If the actual frame duration Da is less than the predicted frame duration Dp, one or more subsequent pulses (e.g., main pulses, runt pulses, etc.) may be modified to reduce visual artifacts (e.g., smearing, tearing, flickering, stutter, motion blur, etc.).

The predicted frame duration may be an estimate of the amount of time between receiving a first frame and receiving the next frame. In some embodiments, the predicted frame duration is calculated using a prediction algorithm. In some embodiments, the predicted frame duration may be calculated based on one or more previous actual frame durations (e.g., the actual time between a first frame and the next frame). For example, the predicted frame duration may be a weighted average of previous actual frame durations. In some embodiments, if the predicted frame duration for a particular frame is shorter than the actual frame duration for that frame, one or more subsequent frame duration predictions may be modified. For example, one or more subsequent frame durations may be reduced to increase the chances that the predicted frame duration is slightly less than the actual frame duration. It may be advantageous to have a predicted frame duration that is close to the actual frame duration (e.g., within 50%, within 25%, within 10%, etc.) and that is less than the actual frame duration.

In some embodiments, the display of a frame is delayed by one or more frames to allow for frame predictions. For example, a first predicted frame duration may be determined (e.g., predicted) and a first frame may be received. The first frame may not be immediately displayed. Based on the first frame's predicted duration and/or one or more previous frames predicted and/or actual frame durations, a predicted frame duration may be calculated for a second frame. The second frame may be received, and the first frame's actual frame duration may be calculated based on the time the second frame is received. The first frame may then be displayed (e.g., after receiving the second frame) with a main pulse based on the first frame's predicted duration (e.g., a fraction of the first frame's predicted duration) and with a runt pulse based on a difference between the first frame's predicted duration and the first frame's actual duration. This process may repeat for subsequent frames.

In some embodiments, if the frame rate falls below a low motion blur threshold, a particular frame can be displayed twice before the next frame is displayed. For example, the low motion blur threshold may be 80 frames per second (e.g., 80 Hz). If the frame rate falls below 80 Hz, each frame may be shown twice (e.g., doubled). The first frame may be displayed for a first frame duration with a main pulse and runt pulse. Then the first frame may be shown again for the same first frame duration with a second main pulse and runt pulse. Then a second frame may be displayed for a second frame duration with another main pulse and runt pulse. The resulting frame rate may be equivalent to double the original frame rate (e.g., if the original frame rate was 75 Hz, it may be doubled and equivalent to 150 Hz). However, in some embodiments, displaying the same frame twice can cause a “double image” visual artifact.

In some embodiments, if the frame rate falls below a low motion blur threshold, a display control circuit may switch from a first mode of operation (e.g., a pulsed backlight mode) to a second mode of operation (e.g., a constant backlight mode or a pulse width modulated (PWM) backlight mode). For example, the low motion blur threshold may be 80 Hz. If the frame rate falls below 80 Hz, instead of pulsing the backlight of the display for each frame, a display control circuit may provide a constant (or pulse width modulated) voltage to the backlight. Operating the backlight in the second mode can prevent the double image problem discussed above. When transitioning from the pulsed backlight mode to the constant voltage mode, one or more pulse durations (e.g., main pulse durations, runt pulse durations, etc.) may be modified before the transition to keep the perceived display brightness the same between the first mode and the second mode and to reduce any display flicker. Similarly, when the frame rate rises above the low motion blur threshold and the display control circuit is transitioning from the second mode to the first mode, one or more pulse durations may be modified immediately following the transition.

In some embodiments, a display can include more than one backlight. For example, a display may have multiple (e.g., 8, 10, etc.) backlight strips that are positioned next to each other to fill the display. In such a case, pixel values of the frame to be displayed may be modified based on the predicted frame duration of the frame.

If a display only has one backlight, pixel values of the frame to be displayed may be modified based on the predicted frame duration of the frame and based on a position of the pixel within the frame. For example, if the pixel values are set (e.g., scanned) from the top of the display to the bottom of the display, the pixels at the bottom of the display may have less time to “settle” before the backlight is pulsed than pixels at the top of the display. Thus, values of pixels at the bottom of the display may be modified more than values of pixels at the top of the display.

The pixel value modifications may be based on one or more lookup tables. For example, a set of lookup tables may be stored for particular predicted frame durations and screen positions. When determining the pixel value for a particular pixel of a frame, a lookup table closest to the predicted frame duration of the frame and closest to the screen position of the pixel may be used. In some embodiments, multiple values may be accessed from lookup tables and a modification value may be obtained by interpolating between the values from the lookup tables.

Advantages of the disclosed embodiments over the existing technology include but are not limited to displays with low motion blur at variable refresh rate. In other words, frames can be displayed at variable refresh rates with few (or none) human-perceptible visual artifacts, such as tearing, double images, smearing, stuttering, or flickering.

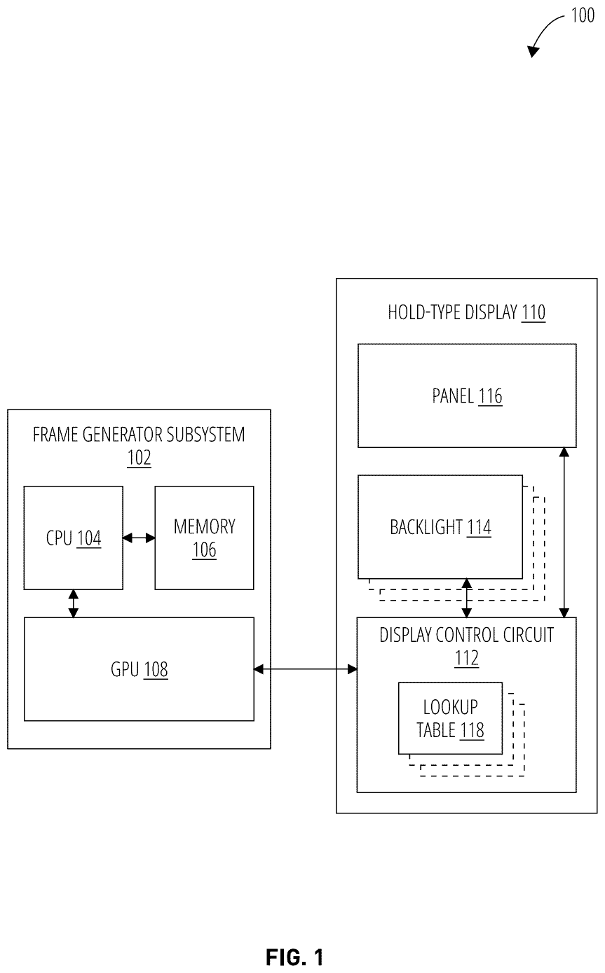

FIG. 1 is a block diagram of an example system 100 for low motion blur displays with variable refresh rates, according to at least one embodiment. System 100 can include frame generator subsystem 102 and hold-type display 110. Frame generator subsystem 102 can generate one or more frames (e.g., image frames) to be displayed by hold-type display 110. In some embodiments, the one or more frames are frames of a video game, a digital media, a virtual reality application, an augmented reality application, and/or the like. The one or more frames may be displayed on hold-type display 110 with low motion blur and variable refresh rates using techniques described herein.

Frame generator subsystem 102 can include one or more processing units (e.g., central processing unit (CPU) 104, graphics processing unit (GPU) 108, etc.) and one or more memory devices (e.g., memory 106) for generating frames to be displayed on hold-type display 110. For example, CPU 104 may execute instructions of an application (e.g., a video game application, a media player application, a virtual reality application, an augmented reality application, etc.). CPU 104 may provide one or more instructions and/or data (e.g., frame data) to a particular processor (e.g., GPU 108) for processing. For example, GPU 108 may perform one or more graphics operations, such as shading, ray tracing, and/or the like. GPU 108 may be connected to hold-type display 110 (e.g., via display control circuit 112), and may provide one or more frames to hold-type display 110 to be displayed with low motion blur.

Hold-type display 110 can include display control circuit 112 and one or more backlights 114. Hold-type display 110 can include panel 116, which is illuminated by the one or more backlights 114. Panel 116 can include one or more pixels for displaying the one or more frames from frame generator subsystem 102. In some embodiments, panel 116 can include a liquid crystal display (LCD).

In some embodiments, panel 116 can include one or more light-emitting diodes (LEDs) and/or organic LEDs (OLEDs). In such a case, each pixel may be “self-illuminating” and may not require a backlight. As such, each LED pixel and/or OLED pixel may be “pulsed” as described herein to achieve low motion blur with variable refresh rates.

Hold-type display 110 can receive frames from frame generator subsystem 102 via display control circuit 112. Display control circuit 112 can include processing circuitry to receive image frames and may predict a duration for a subsequent frame based on one or more previously received frames. The predicted frame duration may be an estimate of the amount of time between receiving a first frame and receiving the next frame. In some embodiments, the predicted frame duration is calculated using a prediction algorithm. In some embodiments, the predicted frame duration may be calculated based on one or more previous actual frame durations (e.g., the actual time between a first frame and the next frame). For example, the predicted frame duration may be a weighted average of previous actual frame durations. In some embodiments, if the predicted frame duration for a particular frame is shorter than the actual frame duration for that frame, one or more subsequent frame duration predictions may be modified. For example, one or more subsequent frame durations may be reduced to increase the chances that the predicted frame duration is slightly less than the actual frame duration. It may be advantageous to have a predicted frame duration that is close to the actual frame duration (e.g., within 50%, within 25%, within 10%, etc.) and that is less than the actual frame duration.

Display control circuit 112 may pulse backlight 114 based on the timing of the received frames and/or the frame duration predictions. Pulsing backlight 114 can include causing a voltage to be supplied to backlight 114. For example, pulsing backlight 114 can include supplying a fixed amount of voltage (e.g., 100%, 50%, 200%, 400%, etc.) to backlight 114 for a particular duration. In some embodiments, display control circuit 112 pulses backlight 114 during a first mode of operation.

In the first mode of operation, display control circuit 112 may cause backlight 114 to pulse twice for a particular frame from frame generator subsystem 102. The duration of the first pulse (e.g., “main pulse”) may be based on a predicted frame duration for the frame. For example, the duration of the main pulse may be a fraction (e.g., 25%) of the predicted frame duration. The duration of the second pulse (e.g., “runt pulse”) may be based on a difference between the predicted frame duration and the actual frame duration.

For example, display control circuit 112 may receive a first frame at time T1. Display control circuit 112 may predict that the second frame will be received at time Tp. Display control circuit 112 may receive the second frame at time Ta. The predicted frame duration (Dp) may be equal to Tp−T1. The actual frame duration (Da) may be equal to Ta−T1. In such a case, the duration of the main pulse may be equal to Fm(Dp), where Fm is a main-pulse fractional coefficient between 0 and 1, inclusive. For example, the duration of the main pulse may be equal to 25% of the predicted duration (e.g., 0.25*Dp).

If the actual frame duration Da is greater than the predicted frame duration Dp, the duration of the runt pulse may be equal to Fr(Da−Dp), where Fr is a runt-pulse fractional coefficient between 0 and 1, inclusive. For example, the duration of the runt pules may be equal to 25% of the difference between the predicted duration and the actual duration (e.g., 0.25*(Da−Dp)). In some embodiments, the main-pulse fractional coefficient Fm is the same as the runt-pulse fractional coefficient Fr.

If the actual frame duration Da is less than the predicted frame duration Dp, one or more subsequent pulses (e.g., main pulses, runt pulses, etc.) may be modified to reduce visual artifacts (e.g., smearing, tearing, flickering, stutter, motion blur, etc.). For example, one or more main pulses may be shortened and/or one or more runt pulses may be lengthened. In some embodiments, if the actual frame duration Da is less than the predicted frame duration Dp, the frame may be illuminated with a main pulse without a corresponding runt pulse. In some embodiments, if the actual frame duration Da is less than the predicted frame duration Dp, the frame may be illuminated with a main pulse and with a “zero” runt pulse. The “zero” runt pulse may have a duration of zero seconds or may supply a voltage of zero to the backlight for a duration greater than zero seconds.

In some embodiments, display control circuit 112 may delay displaying a particular frame to allow for frame predictions. In some embodiments, the delay between display control circuit 112 receiving a frame and causing the frame to be displayed is equal to a fraction of a frame duration (e.g., predicted frame duration, actual frame duration, average frame duration, etc.). In some embodiments, the delay is based on a current frame rate. In some embodiments, the delay is a predetermined value (e.g., 1 millisecond, 3 milliseconds, 10 milliseconds, etc.).

In some embodiments, display control circuit 112 may delay displaying a particular frame by one or more frames. For example, a first predicted frame duration may be determined (e.g., predicted) and a first frame may be received. The first frame may not be immediately displayed. Based on the first frame's predicted duration and/or the predicted and/or actual durations of one or more previous frames, a predicted frame duration may be calculated for a second frame. The second frame may be received, and the first frame's actual frame duration may be calculated based on the time the second frame is received. The first frame may then be displayed (e.g., after receiving the second frame) with a main pulse based on the first frame's predicted duration (e.g., a fraction of the first frame's predicted duration) and with a runt pulse based on a difference between the first frame's predicted duration and the first frame's actual duration, as described above. This process may repeat for subsequent frames.

In some embodiments, instead of pulsing backlight 114 twice for a particular frame, display control circuit 112 may modify the length of a single pulse based on the actual frame duration. For example, display control circuit 112 may pulse backlight 114 one for each frame, with the pulse duration being equal to a fraction (e.g., 25%, 50%, 40%, 30%, etc.) of the actual duration of the frame.

In some embodiments, a low motion blur threshold can be configured by a user. If a frame rate of frame generator subsystem 102 drops below the user-configured low motion blur threshold, display control circuit 112 may not operate backlight 114 in the manner described above. For example, display control circuit 112 may switch from a first mode of operation (e.g., a pulsed backlight mode) to a second mode of operation (e.g., a constant backlight mode or PWM backlight mode).

For example, a first user may configure the low motion blur threshold of a first display to be 80 Hz while a second user may configure the low motion blur threshold of a second display to be 60 Hz. If the frame rate of a frame generator subsystem connected to the first display was equal to 70 Hz (e.g., lower than the first user's low motion blur threshold), the display control circuit of the first display may operate the first display in the second mode of operation. If the frame rate of a frame generator subsystem connected to the second display was equal to 70 Hz (e.g., higher than the second user's low motion blur threshold), the display control circuit of the second display may operate the second display in the first mode of operation discussed above.

In some embodiments, if the frame rate falls below the low motion blur threshold, a particular frame can be displayed twice before the next frame is displayed. For example, the low motion blur threshold may be 80 frames per second (e.g., 80 Hz). If the frame rate falls below 80 Hz, each frame may be shown twice (e.g., doubled). The first frame may be displayed for a first frame duration with a main pulse and runt pulse. Then the first frame may be shown again for the same first frame duration with a second main pulse and runt pulse. Then a second frame may be displayed for a second frame duration with another main pulse and runt pulse. The resulting frame rate may be equivalent to double the original frame rate (e.g., if the original frame rate was 75 Hz, it may be doubled and equivalent to 150 Hz). However, in some embodiments, displaying the same frame twice can cause a “double image” visual artifact.

In some embodiments, one or more processing units (e.g., GPU 108) of frame generator subsystem 102 can be configured to provide a particular frame twice if the frame rate falls below the low motion blur threshold. In such a case, display control circuit 112 may not know frames are being doubled and may simply display each frame as it is received, as discussed above. In some embodiments, GPU 108 may be configured to provide each frame once, regardless of the frame rate and the low motion blur threshold. In such a case, display control circuit 112 may display a frame twice before displaying the next received frame, if the frame rate is below the low motion blur threshold.

In some embodiments, hold-type display 110 may have a lower refresh rate threshold beyond which panel 116 begins to flicker. If GPU 108 is providing frames at a rate less than the lower refresh rate threshold of panel 116, display control circuit 112 may cause a frame to be displayed twice before displaying the next received frame. To avoid a “double image” visual artifact, display control circuit 112 may only illuminate (e.g., cause the backlight to pulse with a main pulse and a runt pulse) the first of each set of frames.

For example, GPU 108 may be providing frames at a rate of 25 frames per second. Panel 116 may have a lower refresh rate threshold of 30 frames per second. Because GPU 108 is providing frames at a rate lower than the lower refresh rate threshold, display control circuit 112 may cause a frame to be displayed twice before displaying the next received frame, artificially increasing the frame rate to 50 frames per second and avoiding the flicker of panel 116 at the low frame rate. Display control circuit 112 may receive a first frame from GPU 108, set the pixel values of panel 116 based on the first frame, as discussed below, and pulse backlight 114 (e.g., with a main pulse and a runt pulse), as described herein, to display the first frame. Display control circuit 112 may receive a second frame from GPU 108, but before displaying the second frame, display control circuit 112 may wait a frame duration of the first frame. Thus, each frame may be shown for two frame durations but may only be illuminated (e.g., may have the backlight pulsed) during the first frame duration.

In some embodiments, the second mode of operation may include causing a constant voltage to be applied to backlight 114. For example, instead of pulsing backlight 114 twice as in the first mode of operation, backlight 114 may be continuously illuminated with a particular voltage. The particular voltage may be selected such that an average voltage supplied to backlight 114 in the first mode of operation is the same as the constant voltage supplied in the second mode of operation.

In some embodiments, the second mode of operations may include causing a pulse width modulated (PWM) voltage to be applied to backlight 114. For example, instead of pulsing backlight 114 twice as in the first mode of operation, backlight 114 may be pulsed extremely quickly (e.g., at a rate of 1 kHz, 2 kHz, etc.) such that an average voltage supplied to backlight 114 in the first mode of operation is the same as the average voltage supplied using the PWM voltage.

Operating the backlight with a constant backlight or PWM backlight can prevent the double image problem discussed above. When transitioning from the pulsed backlight mode to the constant voltage mode or the PWM backlight mode, display control circuit 112 may modify one or more pulse durations (e.g., main pulse durations, runt pulse durations, etc.) before the transition to keep the perceived display brightness the same between the first mode of operation and the second mode of operation and to reduce any display flicker or other visual artifacts. Similarly, when the frame rate rises above the low motion blur threshold and display control circuit 112 is transitioning from the second mode of operation to the first mode of operation, one or more pulse durations may be modified immediately following the transition.

In some embodiments, hold-type display 110 can include more than one backlight 114. For example, hold-type display 110 may include multiple (e.g., 8, 10, etc.) backlight strips that are positioned next to each other to fill panel 116 of hold-type display 110. In such a case, pixel values of the frame to be displayed may be modified (e.g., by display control circuit 112) based on the predicted frame duration of the frame. For example, each frame received from frame generator subsystem 102 may include a plurality of pixel values. Display control circuit 112 may modify one or more pixel values of a frame based on the predicted frame duration of the frame. In some embodiments, if the predicted frame duration is long (e.g., longer than average, longer than the previous frame duration, etc.), the pixel values may be modified less than if the predicted frame duration is short.

In some embodiments, the pixel modification value is determined using one or more lookup tables. For example, display control circuit 112 can include one or more lookup tables 118 that may store pixel modification values. In some embodiments, a first lookup table may store pixel modification values for a first frame duration or frame rate and a second lookup table may store pixel modification values for a second frame duration or frame rate. If the predicted frame duration for a particular frame is between the frame duration of the first lookup table and the frame duration of the second lookup table, a pixel modification value may be determined by interpolating between the two lookup tables.

If hold-type display 110 only has one backlight 114, pixel values of the frame to be displayed may be modified based on the predicted frame duration of the frame and based on a position of the pixel within the frame. For example, if the pixel values are set (e.g., scanned) from the top of hold-type display 110 (or the top of panel 116) to the bottom, the pixels at the bottom may have less time to “settle” before backlight 114 is pulsed than pixels at the top of hold-type display 110 (or panel 116). Thus, values of pixels at the bottom of hold-type display 110 may be modified more than values of pixels at the top of hold-type display 110.

In some embodiments, the pixel modification values for a display with one backlight are determined using one or more lookup tables based on the predicted frame duration of the frame to be displayed and based on a position of the pixel within the frame. For example, a first lookup table may be used for a first frame duration or frame rate and for pixels at the top of the display. A second lookup table may be used for the first frame duration or frame rate and for pixels at the bottom of the display.

In some embodiments, display control circuit 112 may include 4 different sets of 18 lookup tables 118 (for a total of 72 lookup tables 118). Each set of lookup tables may be for a different predicted frame duration. Each table within a set may be for a different screen position. For example, for a display with a 2K resolution, the 18 tables in a set may have pixel modification values for lines 0 through 2176 with a step size of 128 lines. For a display with a 4K resolution, the 18 tables in a set may have pixel modification values for lines 0 through 4352 with a larger step size (e.g., 256 lines, 512 lines, etc.).

When determining the pixel value for a particular pixel of a frame, a lookup table closest to the predicted frame duration of the frame and closest to the screen position of the pixel may be used. In some embodiments, multiple values may be accessed from lookup tables and a modification value may be obtained by interpolating between the values from the lookup tables.

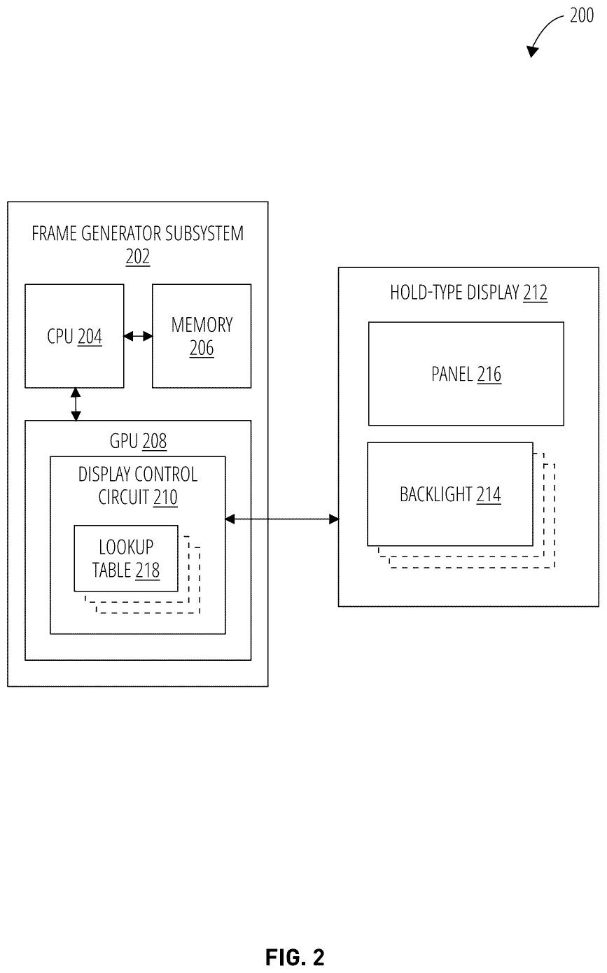

FIG. 2 is a block diagram of an example system 200 for low motion blur displays with variable refresh rates, according to at least one embodiment. System 200 can include frame generator subsystem 202 and hold-type display 212. Frame generator subsystem 202 can include one or more processing units (e.g., CPU 204, GPU 208, etc.) and one or more memory devices (e.g., memory 206) for generating frames to be displayed on hold-type display 212.

Hold-type display 212 can include panel 216, which is illuminated by one or more backlights 214. Panel 216 can include one or more pixels for displaying the one or more frames from frame generator subsystem 202. In some embodiments, panel 216 an include an LCD. In some embodiments, panel 216 can include one or more LEDs and/or OLEDs.

Various components of FIG. 2 can perform operations similar to corresponding components of FIG. 1. For example, display control circuit 210 may control backlight 214 of hold-type display 212 to display one or more frames from GPU 208. In a first mode of operation, display control circuit 210 may pulse backlight 214 twice for each frame: once with a main pulse and again with a runt pulse. The duration of the main pulse and the runt pulse may be determined based on predicted frame durations and actual frame durations, as discussed above.

If the frame rate falls below a low motion blur threshold, display control circuit 210 may control backlight 214 in a second mode of operation, which can include supplying a constant voltage to backlight 214 or supplying a PWM voltage to backlight 214. Display control circuit 210 may also modify values of pixels within a particular frame using pixel modification values from lookup tables 218, as discussed above.

While hold-type display 110 of FIG. 1 was controlled by display control circuit 112 contained within hold-type display 110, hold-type display 212 of FIG. 2 may be controlled by display control circuit 210 contained within GPU 208. System 100 may depict a desktop computer system with a detachable display connected to frame generator subsystem 102, whereas system 200 may depict a laptop computer system with a display affixed to frame generator subsystem 202.

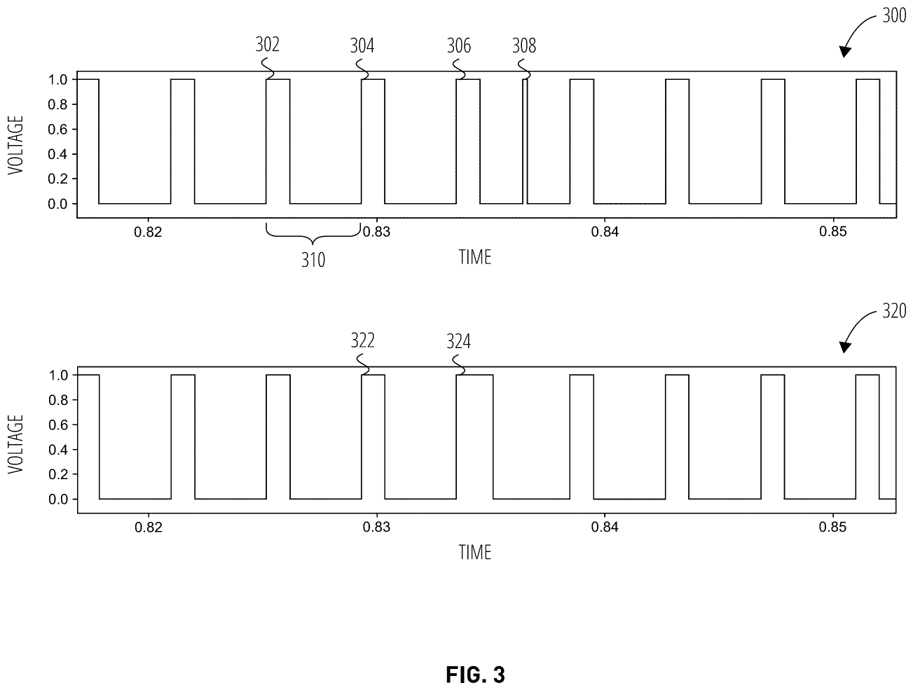

FIG. 3 includes example voltage graphs 300 and 320 depicting voltage provided to a backlight of a hold-type display for low motion blur with variable refresh rates, according to at least one embodiment. For example, voltage graph 300 may depict voltage provided to backlight 114 of hold-type display 110 of FIG. 1 while operating in a first mode (e.g., a pulsed backlight mode). Voltage graph 300 may include multiple main pulses, such as main pulse 302, main pulse 304, and main pulse 306. Voltage graph 300 may also include one or more runt pulses, such as runt pulse 308.

Main pulse 302 may correspond to a first frame. The first frame may have an actual frame duration equal to frame duration 310 (e.g., the time between receiving the first frame and receiving a second frame). The length of main pulse 302 may be equal to a fraction of a predicted frame duration corresponding to the first frame. For example, the length of main pulse 302 may be equal to 25% of a predicted frame duration for the first frame. In other words, a fixed voltage (e.g., 100% voltage) may be provided to a display backlight for 25% of a predicted frame duration and 0 voltage may be provided to the display backlight for the remaining 75% of the predicted frame duration. If the predicted frame duration for the first frame was equal to the actual frame duration of the first frame, main pulse 302 may not have a corresponding runt pulse.

Main pulse 304 may correspond to a second frame. The second frame may have a corresponding actual frame duration. The length of main pulse 304 may be equal to a fraction of a predicted frame duration corresponding to the second frame. For example, the length of main pulse 304 may be equal to 25% of the predicted frame duration for the second frame. If the predicted frame duration for the second frame was equal to the actual frame duration of the second frame, main pulse 304 may not have a corresponding runt pulse.

Main pulse 306 may correspond to a third frame. The third frame may have a corresponding actual frame duration. The length of main pulse 306 may be equal to a fraction of a predicted frame duration corresponding to the third frame. For example, the length of main pulse 306 may be equal to 25% of the predicted frame duration for the third frame. Main pulse 306 has a corresponding runt pulse 308, indicating that the predicted frame duration was shorter than the actual frame duration. The length of runt pulse 308 may be equal to a fraction of the difference between the predicted frame duration and the actual frame duration of the third frame. For example, the length of runt pulse 308 may be 25% of the difference between the longer actual frame duration and the shorter predicted frame duration. In some embodiments, runt pulse 308 may be positioned midway between (e.g., at the middle of) main pulse 306 and the following main pulse.

Voltage graph 320 may depict voltage provided to backlight 114 of hold-type display 110 of FIG. 1 while operating in an alternative first mode. In the alternative first mode, a backlight of a display may only be pulsed once for each frame, with a length of the pulse determined based on an actual frame duration of the frame corresponding to the pulse. For example, main pulse 322 may correspond to a first frame and may have a length equal to a fraction of the actual frame duration of the first frame. Extended pulse 324 may correspond to a second frame. Extended pulse 324 may have a length longer than main pulse 322 because the actual frame duration of the second frame is longer than the actual frame duration of the first frame. The length of each pulse may be a fixed fraction of the actual frame duration of the frame corresponding to the pulse. For example, the length of main pulse 322 may be 25% of the actual frame duration of the first frame, and the length of extended pulse 324 may be 25% of the actual frame duration of the second frame.

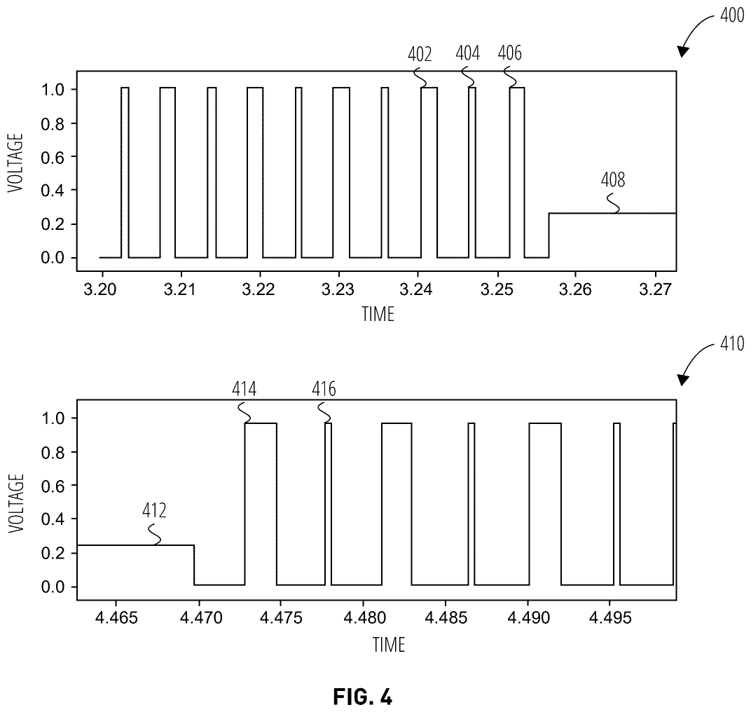

FIG. 4 includes example voltage graphs 400 and 410 depicting voltage provided to a backlight of a hold-type display when transitioning from a low motion blur mode to a constant backlight mode and back, according to at least one embodiment. For example, voltage graph 400 may depict voltage provided to backlight 114 of hold-type display 110 of FIG. 1 while transitioning from a first mode of operation (e.g., a pulsed backlight mode) to a second mode of operation (e.g., a constant backlight mode). Voltage graph 400 may include one or more main pulses, such as main pulse 402 and main pulse 406. Voltage graph 400 may also include one or more runt pulses, such as runt pulse 404.

Main pulse 402 and runt pulse 404 may correspond to a first frame and may have lengths as described above in relation to FIG. 3. Main pulse 406 may correspond to a second frame and may have a length equal to a fraction of the predicted frame duration of the second frame. After receiving the second frame, the display control circuit of the display may transition to a second mode of operation (e.g., a constant backlight mode). For example, the display control circuit of the display may transition to the second mode of operation after a frame rate drops below a low motion blur threshold.

Constant voltage 408 may indicate the voltage supplied to the backlight during the second mode of operation. Constant voltage 408 may be selected such that an average voltage supplied to the backlight during the first mode of operation (or during a subset of the first mode of operation) is equal to constant voltage 408. In some embodiments, when transitioning from the first mode of operation to the second mode of operation, a main pulse (e.g., main pulse 406) may not have a corresponding runt pulse. In some embodiments, the length of one or more main pulses and/or runt pulses before the transition are modified (e.g., lengthened, shortened, etc.) to reduce visual artifacts around the transition.

Voltage graph 410 may depict voltage provided to backlight 114 of hold-type display 110 of FIG. 1 while transitioning from a second mode of operation (e.g., a constant backlight mode) to a first mode of operation (e.g., a pulsed backlight mode). Voltage graph 410 may include one or more main pulses, such as main pulse 414. Voltage graph 410 may also include one or more runt pulses, such as runt pulse 416.

Constant voltage 412 may indicate the voltage supplied to the backlight during the second mode of operation. After receiving one or more frames during the second mode of operation, the display control circuit of the display may transition to the first mode of operation (e.g., the pulsed backlight mode). For example, the display control circuit of the display may transition to the first mode of operation after a frame rate rises above a low motion blur threshold.

Main pulse 414 and runt pulse 416 may correspond to a first frame received after transitioning back to the first mode of operation. The length of main pulse 414 may be based on a fraction of the predicted frame duration of the first frame. The length of runt pulse 416 may be based on a fraction of the difference between an actual frame duration of the first frame and the predicted frame duration of the first frame. In some embodiments, the length of one or more main pulses and/or runt pulses after the transition are modified (e.g., lengthened, shortened, etc.) to reduce visual artifacts around the transition.

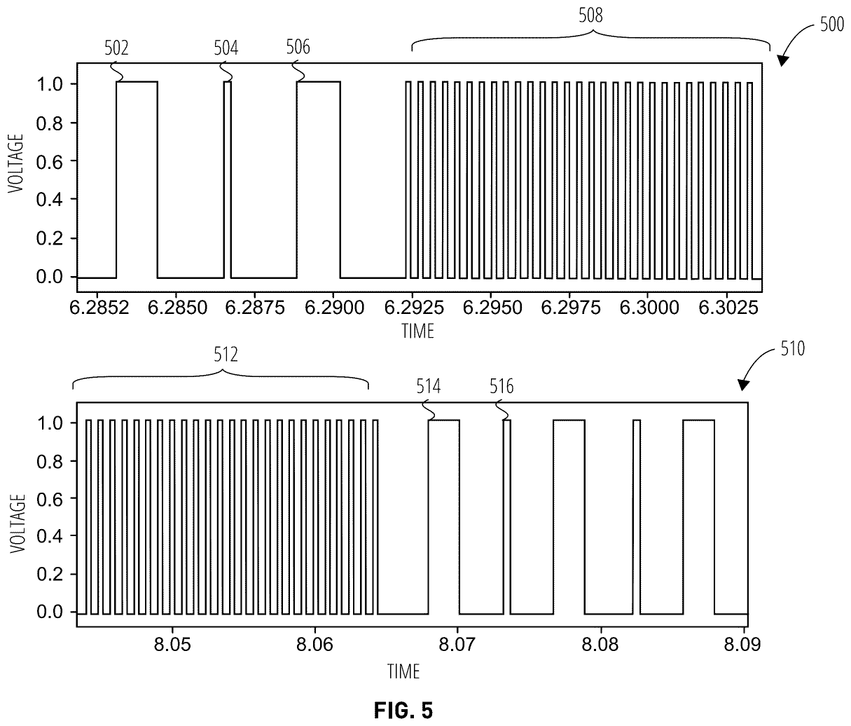

FIG. 5 includes example voltage graphs 500 and 510 depicting voltage provided to a backlight of a hold-type display when transitioning from a low motion blur mode to a pulse width modulation backlight mode and back, according to at least one embodiment. For example, voltage graph 500 may depict voltage provided to backlight 114 of hold-type display 110 of FIG. 1 while transitioning from a first mode of operation (e.g., a pulsed backlight mode) to a second mode of operation (e.g., a PWM backlight mode). Voltage graph 500 may include one or more main pulses, such as main pulse 502 and main pulse 506. Voltage graph 500 may also include one or more runt pulses, such as runt pulse 504.

Main pulse 502 and runt pulse 504 may correspond to a first frame and may have lengths as described above in relation to FIG. 3. Main pulse 506 may correspond to a second frame and may have a length equal to a fraction of the predicted frame duration of the second frame. After receiving the second frame, the display control circuit of the display may transition to a second mode of operation (e.g., a PWM backlight mode). For example, the display control circuit of the display may transition to the second mode of operation after a frame rate drops below a low motion blur threshold.

PWM voltage 508 may indicate the voltage supplied to the backlight during the second mode of operation. During the second mode of operation, voltage may be supplied to the backlight at a high frequency (e.g., 1 kHz, 2 kHz, etc.), such that an average voltage supplied to the backlight during the second mode of operation is equal to an average voltage supplied to the backlight during the first mode of operation. In some embodiments, when transitioning from the first mode of operation to the second mode of operation, a main pulse (e.g., main pulse 506) may not have a corresponding runt pulse. In some embodiments, the length of one or more main pulses and/or runt pulses before the transition are modified (e.g., lengthened, shortened, etc.) to reduce visual artifacts around the transition.

Voltage graph 510 may depict voltage provided to backlight 114 of hold-type display 110 of FIG. 1 while transitioning from a second mode of operation (e.g., a PWM backlight mode) to a first mode of operation (e.g., a pulsed backlight mode). Voltage graph 510 may include one or more main pulses, such as main pulse 514. Voltage graph 510 may also include one or more runt pulses, such as runt pulse 516.

PWM voltage 512 may indicate the voltage supplied to the backlight during the second mode of operation. After receiving one or more frames during the second mode of operation, the display control circuit of the display may transition to the first mode of operation (e.g., the pulsed backlight mode). For example, the display control circuit of the display may transition to the first mode of operation after a frame rate rises above a low motion blur threshold.

Main pulse 514 and runt pulse 516 may correspond to a first frame received after transitioning back to the first mode of operation. The length of main pulse 514 may be based on a fraction of the predicted frame duration of the first frame. The length of runt pulse 516 may be based on a fraction of the difference between an actual frame duration of the first frame and the predicted frame duration of the first frame. In some embodiments, the length of one or more main pulses and/or runt pulses after the transition are modified (e.g., lengthened, shortened, etc.) to reduce visual artifacts around the transition.

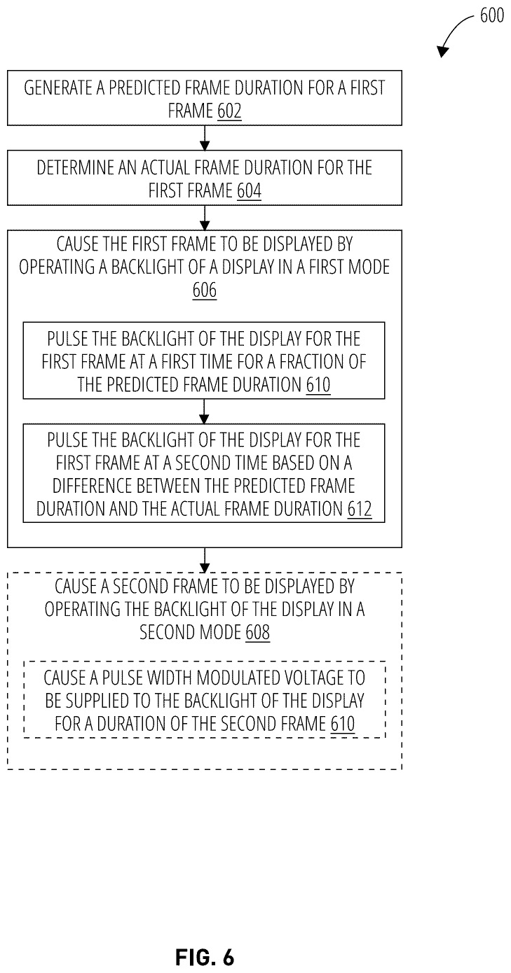

FIG. 6 is a flow diagram of an example method for low motion blur displays with variable refresh rates, according to at least one embodiment.

Method 600 can be performed using one or more processing units (e.g., CPUs, GPUs, accelerators, physics processing units (PPUs), data processing units (DPUs), etc.), which may include (or communicate with) one or more memory devices. In at least one embodiment, method 600 can be performed using a processing device or processing devices. In at least one embodiment, method 600 can be performed by display control circuit 112 of FIG. 1. In at least one embodiment, method 600 can be performed by display control circuit 210 of FIG. 2. In at least one embodiment, processing units performing any of method 600 can be executing instructions stored on a non-transient computer readable storage media. In at least one embodiment, method 600 can be performed using multiple processing threads (e.g., CPU threads and/or GPU threads), individual threads executing one or more individual functions, routines, subroutines, or operations of the method. In at least one embodiment, processing threads implementing method 600 can be synchronized (e.g., using semaphores, critical sections, and/or other thread synchronization mechanisms). Alternatively, processing threads implementing method 600 can be executed asynchronously with respect to each other. Various operations of method 600 can be performed in a different order compared with the order shown in FIG. 6. Some operations of method 600 can be performed concurrently with other operations. In at least one embodiment, one or more operations shown in FIG. 6 may not always be performed.

At block 602, processing units executing method 600 can generate a predicted frame duration for a first frame. At block 604, processing units can determine an actual frame duration for the first frame. At block 606, processing units can cause the first frame to be displayed by operating a backlight of a display in a first mode.

To cause the first frame to be displayed by operating the backlight of the display in the first mode, processing units may, at block 610, pulse the backlight of the display for the first frame at a first time for a fraction of the predicted frame duration. To pulse the backlight of the display for the first frame at the first time for a fraction of the predicted frame duration, processing units may cause voltage to be supplied to the backlight of the display for a fraction of the predicted frame duration.

At block 612, processing units may pulse the backlight of the display for the first frame at a second time based on a difference between the predicted frame duration and the actual frame duration. In some embodiments, to pulse the backlight of the display for the first frame at the second time based on the difference between the predicted frame duration and the actual frame duration, processing units may cause voltage to be supplied to the backlight of the display for a fraction of the difference between the predicted frame duration and the actual frame duration. In some embodiments, if the actual frame duration is less than the predicted frame duration, to pulse the backlight of the display for the first frame at the second time based on the difference between the predicted fame duration and the actual frame duration, processing units may cause voltage to be supplied to the backlight of the display for a duration of zero seconds. In some embodiments, if the actual frame duration is less than the predicted frame duration, to pulse the backlight of the display for the first frame at the second time based on the difference between the predicted fame duration and the actual frame duration, processing units may cause a zero voltage to be supplied to the backlight of the display for a duration greater than zero seconds.

In some embodiments, the actual frame duration is longer than the predicted frame duration and the second time is in the middle of the actual frame duration.

In some embodiments, the actual frame duration is shorter than the predicted frame duration, and processing units can further generate a shorter predicted frame duration for a second frame.

In some embodiments, responsive to a frame rate falling below a predetermined threshold, processing units can cause a second frame to a be displayed twice by operating the backlight of the display in the first mode before causing a third frame to be displayed.

In some embodiments, at block 608, processing units can cause a second frame to be displayed by operating the backlight of the display in a second mode. In some embodiments, an average brightness of the backlight of the display in the second mode is the same as an average brightness of the backlight of the display in the first mode. In some embodiments, causing the second frame to be displayed by operating the backlight of the display in the second mode is performed responsive to a frame rate falling below a predetermined threshold.

In some embodiments, to cause the second frame to be displayed by operating the backlight of the display in the second mode, processing units may, at block 610, cause a pulse width modulated voltage to be supplied to the backlight of the display for a duration of the second frame.

In some embodiments, to cause the second frame to be displayed by operating the backlight of the display in the second mode, processing units may cause a constant voltage to be supplied to the backlight of the display for a duration of the second frame.

In some embodiments, before causing the second frame to be displayed by operating the backlight of the display in the second mode, processing units may modify one or more pulses of one or more previous frames displayed in the first mode.

In some embodiments, the display comprises a single backlight and a value of a pixel of the first frame is modified based on the predicted frame duration for the first frame and a position of the pixel within the first frame. In some embodiments, the display comprises more than one backlight and a value of a pixel of the first frame is modified based on the predicted frame duration for the first frame.

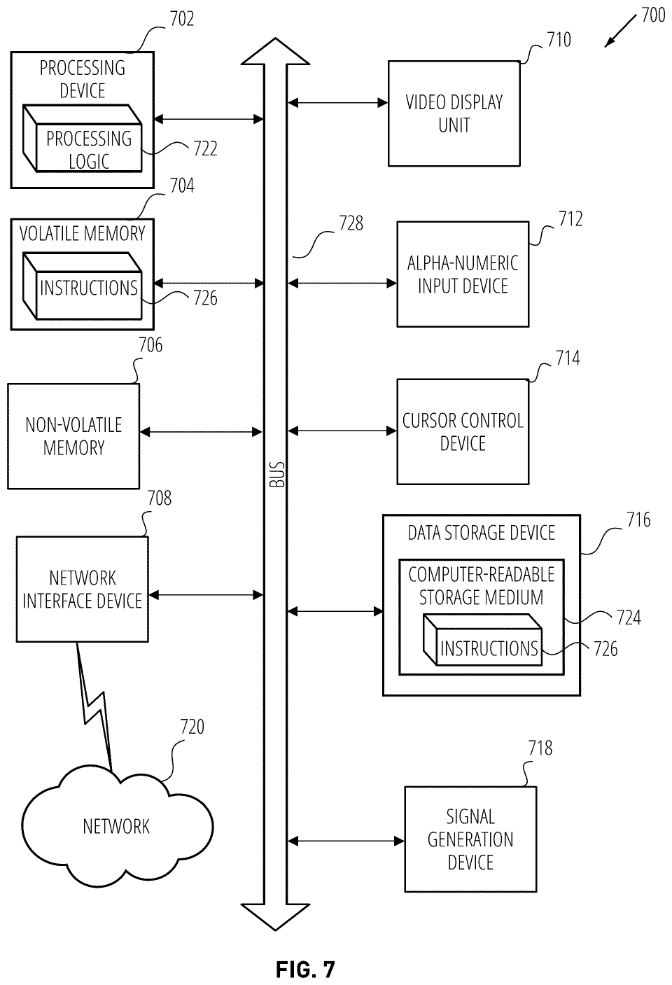

FIG. 7 is a block diagram illustrating an exemplary computer system, in accordance with at least one embodiment of the present disclosure. The computer system 700 can correspond to system 100, described with respect to FIG. 1. The computer system 700 can also correspond to system 200, described with respect to FIG. 2. Computer system 700 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processing device (processor) 702, a main memory 704 (e.g., read-only memory (ROM), flash memory, dynamic random access memory (DRAM) such as synchronous DRAM (SDRAM), double data rate (DDR SDRAM), or DRAM (RDRAM), etc.), a static memory 706 (e.g., flash memory, static random access memory (SRAM), etc.), and a data storage device 716, which communicate with each other via a bus 728.

Processor (processing device) 702 represents one or more general-purpose processing devices such as a microprocessor, central processing unit, or the like, and may include processing logic 722. More particularly, the processor 702 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 702 can also be one or more special-purpose processing devices such as an application specific integrated circuit (ASIC), a field programmable gate array (FPGA), a digital signal processor (DSP), network processor, or the like. The processor 702 is configured to execute instructions 726 (e.g., for generating threat indicator alerts) for performing the operations discussed herein.

The computer system 700 can further include a network interface device 708. The computer system 700 also can include a video display unit 710 (e.g., a liquid crystal display (LCD) or a cathode ray tube (CRT)), an input device 712 (e.g., a keyboard, and alphanumeric keyboard, a motion sensing input device, touch screen), a cursor control device 714 (e.g., a mouse), and a signal generation device 718 (e.g., a speaker). In some embodiments, computer system 700 may not include video display unit 710, input device 712, and/or cursor control device 714 (e.g., in a headless configuration).

The data storage device 716 can include a non-transitory machine-readable storage medium 724 (also computer-readable storage medium) on which is stored one or more sets of instructions 726 (e.g., for low motion blur for displays with variable refresh rates) embodying any one or more of the methodologies or functions described herein. The instructions 726 can also reside, completely or at least partially, within the main memory 704 and/or within the processor 702 during execution thereof by the computer system 700, the main memory 704 and the processor 702 also constituting machine-readable storage media. The instructions can further be transmitted or received over a network 720 via the network interface device 708.

In one implementation, the instructions 726 include instructions for low motion blur for displays with variable refresh rates. While the computer-readable storage medium 724 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two but can be more when so indicated either explicitly or by context. Further, unless stated otherwise or otherwise clear from context, the phrase “based on” means “based at least in part on” or “based at least on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, in some embodiments, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
generating a predicted frame duration for a first frame;
determining an actual frame duration for the first frame; and
causing the first frame to be displayed by operating a backlight of a display in a first mode, wherein operating the backlight of the display in the first mode comprises:
pulsing the backlight of the display for the first frame at a first time for a fraction of the predicted frame duration; and
pulsing the backlight of the display for the first frame at a second time based on a difference between the predicted frame duration and the actual frame duration.

2. The method of claim 1, wherein the pulsing the backlight of the display for the first frame at the first time comprises causing voltage to be supplied to the backlight of the display for a fraction of the predicted frame duration.

3. The method of claim 1, wherein the actual frame duration is longer than the predicted frame duration, and wherein the second time is in the middle of the actual frame duration.

4. The method of claim 3, wherein the pulsing the backlight of the display for the first frame at the second time comprises causing voltage to be supplied to the backlight of the display for a fraction of the difference between the predicted frame duration and the actual frame duration.

5. The method of claim 1, wherein the actual frame duration is shorter than the predicted frame duration, the method further comprising generating a shorter predicted frame duration for a second frame.

6. The method of claim 1, further comprising, responsive to a frame rate falling below a predetermined threshold, causing a second frame to be displayed twice by operating the backlight of the display in the first mode before causing a third frame to be displayed.

7. The method of claim 1, further comprising, responsive to a frame rate falling below a predetermined threshold, causing a second frame to be displayed by operating the backlight of the display in a second mode, wherein an average brightness of the backlight of the display in the second mode is the same as an average brightness of the backlight of the display in the first mode.

8. The method of claim 7, wherein causing the second frame to be displayed by operating the backlight of the display in the second mode comprises at least one of:
causing a constant voltage to be supplied to the backlight of the display for a duration of the second frame; or
causing a pulse width modulated voltage to be supplied to the backlight of the display for the duration of the second frame.

9. The method of claim 7, the method further comprising:
before causing the second frame to be displayed by operating the backlight of the display in the second mode, modifying one or more pulses of one or more previous frames displayed in the first mode.

10. The method of claim 1, wherein the display comprises a single backlight, and wherein a value of a pixel of the first frame is modified based on the predicted frame duration for the first frame and a position of the pixel within the first frame.

11. The method of claim 1, wherein the display comprises more than one backlight, and wherein a value of a pixel of the first frame is modified based on the predicted frame duration for the first frame.

12. A system comprising:
a processing unit to generate a first frame;
a display; and
a display control circuit coupled between the processing unit and the display, the display control circuit to:
generate a predicted frame duration for the first frame;
determine an actual frame duration for the first frame; and
cause the first frame to be displayed by operating a backlight of the display in a first mode, wherein to operate the backlight of the display in the first mode, the display control circuit is to:
pulse the backlight of the display for the first frame at a first time for a fraction of the predicted frame duration; and
pulse the backlight of the display for the first frame at a second time based on a difference between the predicted frame duration and the actual frame duration.

13. The system of claim 12, wherein the pulsing the backlight of the display for the first frame at the first time comprises causing voltage to be supplied to the backlight of the display for a fraction of the predicted frame duration.

14. The system of claim 12, wherein the actual frame duration is longer than the predicted frame duration, and wherein the second time is in the middle of the actual frame duration.

15. The system of claim 14, wherein the pulsing the backlight of the display for the first frame at the second time comprises causing voltage to be supplied to the backlight of the display for a fraction of the difference between the predicted frame duration and the actual frame duration.

16. The system of claim 12, wherein the actual frame duration is shorter than the predicted frame duration, the display control circuit further to generate a shorter predicted frame duration for a second frame.

17. The system of claim 12, the display control circuit further to, responsive to a frame rate falling below a predetermined threshold, causing a second frame to be displayed twice by operating the backlight of the display in the first mode before causing a third frame to be displayed.

18. The system of claim 12, the display control circuit further to, responsive to a frame rate falling below a predetermined threshold, causing a second frame to be displayed by operating the backlight of the display in a second mode, wherein an average brightness of the backlight of the display in the second mode is the same as an average brightness of the backlight of the display in the first mode.

19. The system of claim 18, wherein to cause the second frame to be displayed by operating the backlight of the display in the second mode, the display control circuit is further to at least one of:
cause a constant voltage to be supplied to the backlight of the display for a duration of the second frame; or
cause a pulse width modulated voltage to be supplied to the backlight of the display for the duration of the second frame.

20. A system comprising:
one or more processors; and
a display coupled to the one or more processors, the one or more processors to:
generate a predicted frame duration for a first frame of a particular processor of the one or more processors;
determine an actual frame duration for the first frame; and
cause the first frame to be displayed by operating a backlight of the display in a first mode, wherein to operate the backlight of the display in the first mode, the one or more processors are to:
pulse the backlight of the display for the first frame at a first time for a fraction of the predicted frame duration; and
pulse the backlight of the display for the first frame at a second time based on a difference between the predicted frame duration and the actual frame duration.
